(19) United States
(12) Patent Application Publication
(10) Pub. No.: US 2011/0252308 A1
(43) Pub. Date: Oct. 13, 2011

(54) GENERATING COMPUTER PROGRAM CODE FROM OPEN MARKUP LANGUAGE DOCUMENTS

(75) Inventors: Dong-Hui Zhang, Beijing (CN); Xiaoming Yin, Beijing (CN); Yuanfeng Wen, Beijing (CN); Linda Lanqing D. Brownell, Beijing (CN); Tarik Nesh-Nash, Tanger (MA); Zeyad Rajabi, Bellevue, WA (US)

(73) Assignee: Microsoft Corporation, Redmond, WA (US)

(21) Appl. No.: 12/756,588

(22) Filed: Apr. 8, 2010

(51) Int. Cl. G06F 17/24; G06F 9/44; G06F 17/00

(52) U.S. Cl. 715/235; 715/234; 719/328

(57) ABSTRACT

Computer program code may be generated from open markup language documents. A computer may be utilized to load source and target open markup language documents. The computer may then be utilized to compare content in the source open markup language document and content in the target open markup language document to determine differences. After the comparison has been made, the computer may be utilized to generate computer program code representative of the differences between the source and target markup language documents.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Open file formats have been developed to represent electronic documents generated by proprietary software platforms such as office productivity applications. The use of open file formats allows electronic office documents such as word processing documents, spreadsheet documents, and presentation documents to be shared across multiple platforms and for viewing in a Web browser. One current open file format, which utilizes extensible markup language (“XML”) for representing electronic office documents, is “Open XML” developed by MICROSOFT CORPORATION of Redmond, Wash. The Open XML format defines a set of XML markup vocabularies for office electronic documents as well as mathematical formulae, graphics, bibliographies, etc., which are utilized within these documents. Currently however, the process of generating content to conform to open file formats (such as Open XML) is very complex, even for software application developers. Thus, developers are often faced with a steep learning curve prior to generating content. For example, the process of making changes to an existing electronic office document (e.g., adding a chart to a spreadsheet document) may require making changes to several lines of XML content which are located in several places in an open file format package. As a result, it is often difficult for developers to fully understand where changes in an electronic office document need to be made when working with open file formats. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for generating computer program code from open markup language documents. A computer may be utilized to load source and target open markup language documents. The computer may then be utilized to compare content in the source open markup language document and content in the target open markup language document to determine differences. After the comparison has been made, the computer may be utilized to generate computer program code representative of the differences between the source and target markup language documents.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating various software components which may be utilized in generating computer program code from open markup language documents, in accordance with various embodiments;

FIG. 2 is a block diagram illustrating a computer which may be utilized for generating computer program code from open markup language documents, in accordance with various embodiments;

FIG. 3 is a flow diagram illustrating a routine for generating computer program code from open markup language documents, in accordance with an embodiment; and

FIG. 4 is a flow diagram illustrating a routine for generating computer program code from open markup language parts, in accordance with an embodiment.

### DETAILED DESCRIPTION

Embodiments are provided for generating computer program code from open markup language documents. A computer may be utilized to load source and target open markup language documents. The computer may then be utilized to compare content in the source open markup language document and content in the target open markup language document to determine differences. After the comparison has been made, the computer may be utilized to generate computer program code representative of the differences between the source and target markup language documents.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

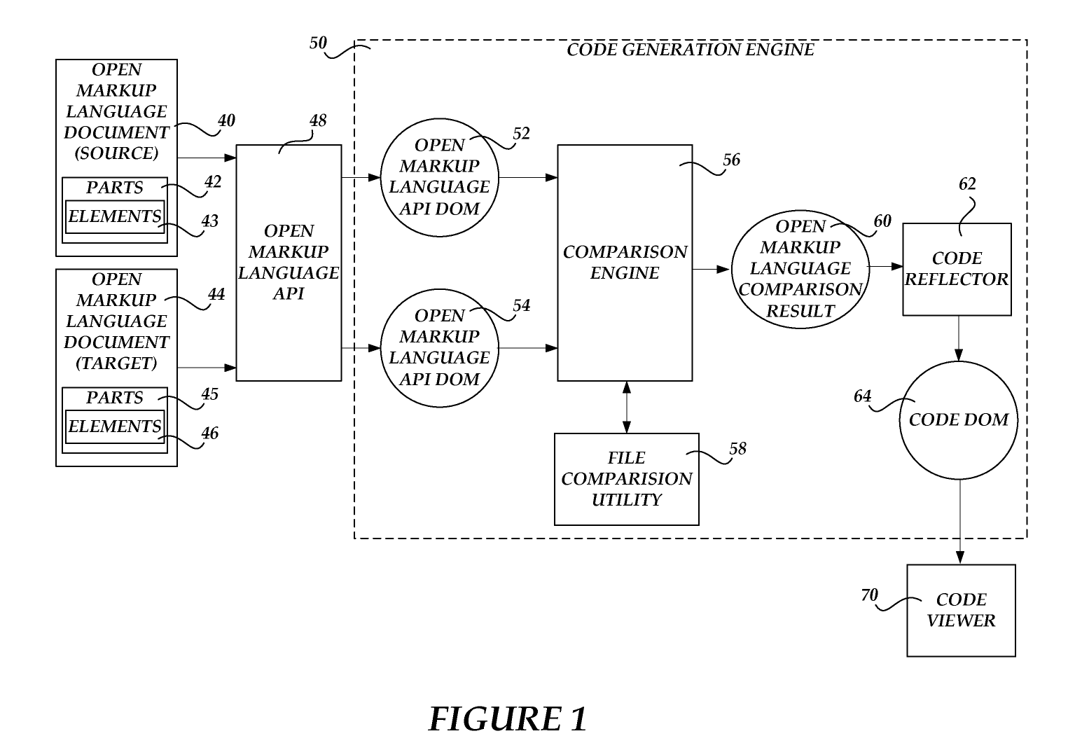

Referring now to the drawings, in which like numerals represent like elements through the several figures, various aspects of the present invention will be described. FIG. 1 is a block diagram illustrating various software components which may be utilized in generating computer program code from open markup language documents, in accordance with various embodiments. The software components include a source open markup language document 40 and a target open markup language document 44. In accordance with various embodiments, the source open markup language document 40 and the target open markup language document 44 may comprise extensible markup language (“XML”) representations of an electronic office document (such as a word processing document, a spreadsheet document, or a presentation document) which has been formatted according to the Open XML file format developed by MICROSOFT CORPORATION of Redmond, Wash. In particular, the target open markup language document 44 may comprise an edited version of an electronic office document (or section of an electronic document) represented by the source open markup language document 40. For example, the target open markup language document 44 may represent a word processing document in which content (e.g., paragraphs, text, document styles, comments, headers, footers, etc.) has been added, deleted, or modified with respect to the source open markup language document 40.

The source open markup language document 40 may include one or more parts 42 and elements 43. The target open markup language document 44 may include one or more parts 45 and elements 46. It should be appreciated that the parts 42 and 45 may comprise open markup language content in the source open markup language document 40 and the target open markup language document 44. That is, the parts 42 and 45 may represent one or more parts of an electronic office document. For example, in accordance with an embodiment, the parts 42 and 45 may include, but are not limited to, a main document part (e.g., text, paragraphs, etc.), a styles document part, a comments document part, a header document part, a footer document part, and a chart document part. The elements 43 and 46 may represent open markup language elements (e.g., XML elements) utilized to form the parts 42 and 45 in the source open markup language document 40 and the target open markup language document 44.

The software components may further include an open markup language application programming interface (“API”) 48. In accordance with an embodiment, the open markup language API 48 may be configured to load the source open markup language document 40 and the target markup language document 44 and generate representations of these documents (i.e., as objects) in one or more document object models (“DOMs”), such as open markup language API DOM 52 and open markup language API DOM 54. In accordance with another embodiment, the open markup language API 48 may be configured to load individual source and target parts 42 and 45 (without loading the entire source and target markup language documents 40 and 44) and generate representations of the parts 42 and 45 (i.e., as objects) in one or more document object models (“DOMs”), such as open markup language API DOM 52 and open markup language API DOM 54. As known to those skilled in the art, a document object model is a cross-platform and language independent convention for presenting an interacting with objects in markup languages, such as XML.

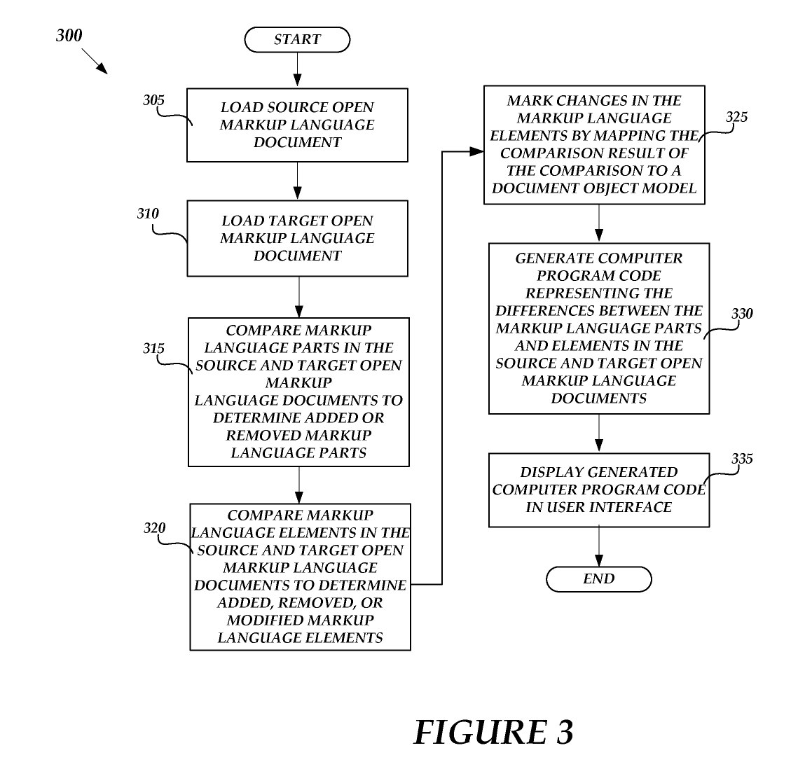

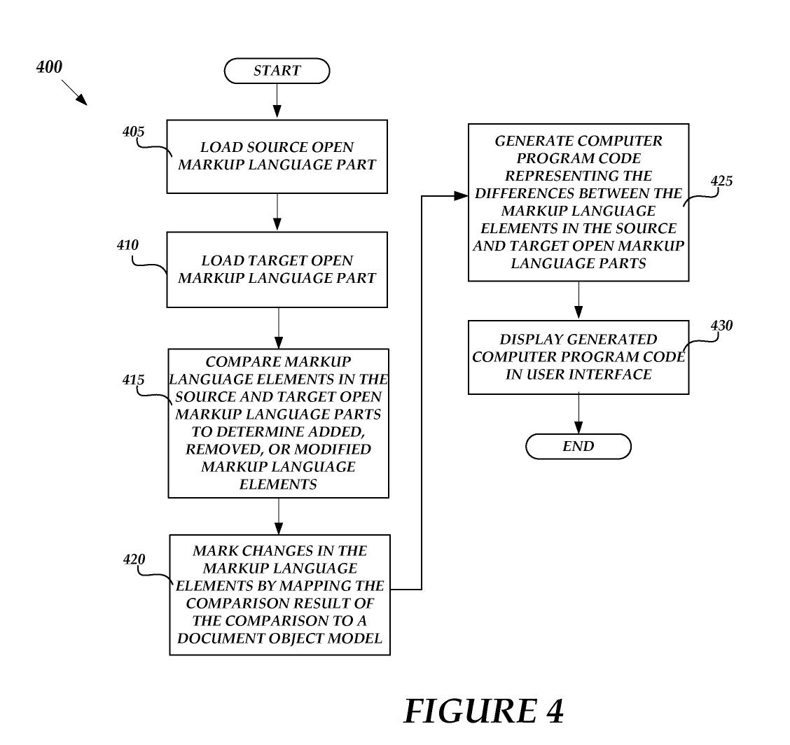

The software components may further include a code generation engine 50 which includes, without limitation, a comparison engine 56, a file comparison utility 58, and a code reflector 62. As will be discussed in greater detail below with respect to the description of FIGS. 3-4, in accordance with various embodiments, the comparison engine 56 may compare the open markup language API DOMs 52 and 54 (generated by the open markup language API 48) to determine differences between the source and target open markup language documents 40 and 44 or between the source and target parts 42 and 45. In accordance with an embodiment in which the open markup language API 48 loads the source and target open markup language documents 40 and 44, the file comparison utility 58 may be utilized to compare the open markup language API DOMs 52 and 54 representing the source and target open markup language documents 40 and 44 or the source ant target parts 42 and 45. In accordance with an embodiment, the file comparison utility 58 may comprise the XML DIFF comparison tool developed by MICROSOFT CORPORATION of Redmond, Wash. In accordance with an embodiment, the comparison engine 56 may be configured to operate in conjunction with the file comparison utility 58 to compare the parts 42 and 45 (represented as objects in the open markup language API DOMs 52 and 54) in the source and target open markup language documents 40 and 44 to determine document parts which have been added or removed. The comparison engine 56 may also be configured to compare the elements 43 and 46 (represented as objects in the open markup language API DOMs 52 and 54) in the source and target open markup language documents 40 and 44 to determine markup language elements which have been added, removed, or modified. In particular, the comparison engine 56 may be configured to compare the content DOMs (i.e., the open markup language API DOMs 52 and 54) of corresponding document parts 42 and 45 in the source and target open markup language documents 40 and 44 by utilizing the file comparison utility, in order to obtain any changes made to the elements 43 and 46. The comparison engine 56 may also be configured to mark changes in the elements 43 and 46 of the source and target markup language documents 40 and 44, by mapping the comparison result (i.e., open markup language comparison result 60) of the elements 43 and 46 to the open markup language API DOM 52.

In accordance with an embodiment, the code reflector 62 in the code generation engine 50 may be configured to analyze the open markup language comparison result 60, generate computer program code for any part-level changes (e.g., added or removed parts 42 or changes inside of a part 42) in the source open markup language document 40, and further generate computer program code (in code DOM 64) for any markup language element changes (i.e., changes in the elements 43) inside the parts 42 in the source open markup language document 40. In accordance with another embodiment, the code reflector 62 in the code generation engine 50 may be configured to analyze the open markup language comparison result 60 and generate computer program code (in the code DOM 64) for any markup language element changes (i.e., changes in the elements 43) inside one or more of the parts 42. It should be appreciated that, in accordance with an embodiment, the code generation engine 50 may leverage the .NET Reflecting technology which is known to those skilled in the art.

The software components may further include a code viewer 70. In accordance with various embodiments, the code viewer 70 may be configured to receive the computer program code in the code DOM 64 and generate a user interface to display the computer program code for viewing.

### Exemplary Operating Environment

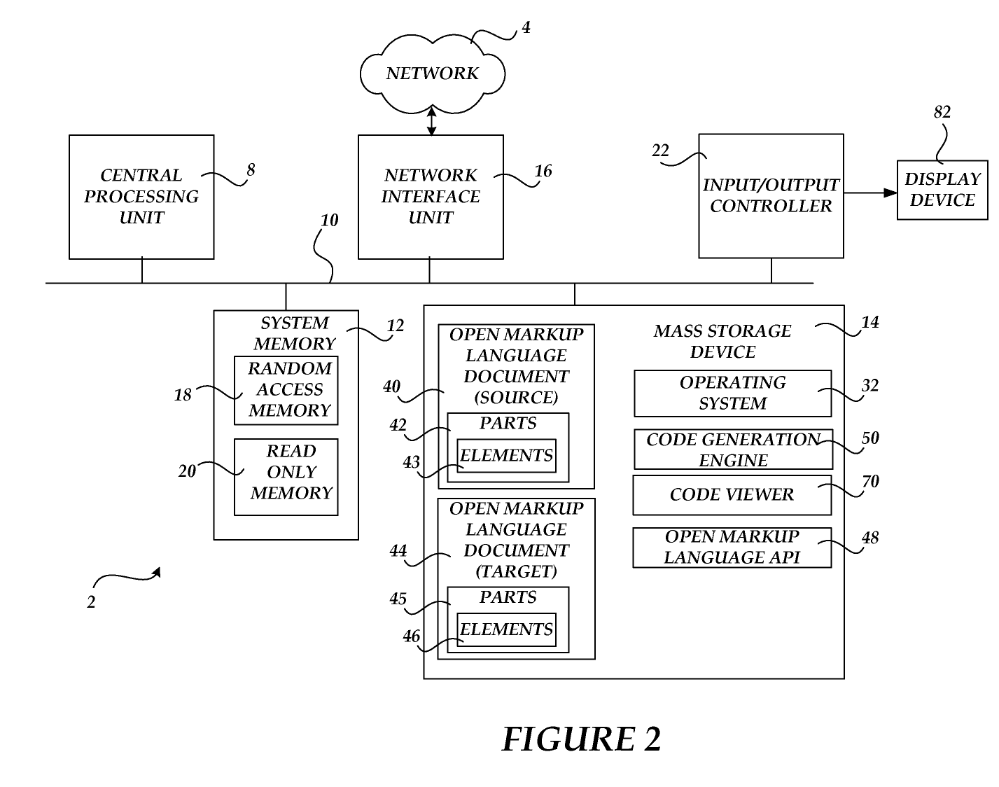

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows a computer 2 which may comprise any type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The computer 2 may further include a mass storage device 14 for storing an operating system 32, the source open markup language document 40 (which comprises the parts 42 and the elements 43 discussed above), the target open markup language document 44 (which comprises the parts 45 and the elements 46 discussed above), the open markup language API 48, the code generation engine 50, and the code viewer 70. In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the computer 2. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments, the computer 2 may operate in a networked environment using logical connections to remote computers through a network 4 which may comprise, for example, a local network or a wide area network (e.g., the Internet). The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, voice input, and/or other means. Similarly, an input/output controller 22 may provide output to a display device 82, a printer, or other type of output device. Additionally, a touch screen can serve as an input and an output mechanism.

FIG. 3 is a flow diagram illustrating a routine 300 for generating computer program code from open markup language documents, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 3-4 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 300 begins at operation 305, where the computer 2 loads the source open markup language document 40. In particular, the central processing unit 8 in the computer 2 may utilize the open markup language API 48 to load the source open markup language document 40 as a document object model (i.e., the open markup language API DOM 52) representing the markup language parts 42 and the elements 43 in the source open markup language document 40.

From operation 305, the routine 300 continues to operation 310, where the computer 2 loads the target open markup language document 44. In particular, the central processing unit 8 in the computer 2 may utilize the target markup language API 48 to load the target open markup language document 44 as a document object model (i.e., the open markup language API DOM 52) representing the markup language parts 45 and the elements 46 in the target open markup language document 44. It should be understood that in accordance with other embodiments, the operations 305 and 310 may be reversed. That is, the computer 2 may load the target open markup language document 44 prior to loading the source open markup language document 40.

From operation 310 the routine 300 continues to operation 315, where the computer 2 utilizes the comparison engine 56 and the file comparison utility 58 to compare the parts 42 and 45 (in the source and target markup language documents 40 and 44) to determine added or removed markup language parts. In particular, the comparison engine 56 and the file comparison utility 58 may be utilized to compare a document structure of the source open markup language document 40 and a document structure of the target open markup language document 44 to determine the addition markup language parts to the source open markup language document 40, to determine the removal of markup language parts from the source open markup language document 40, or to determine that there is no difference between a markup language part in the source open markup language document 40 and a markup language part in the target markup language document 44. In accordance with an embodiment, the comparison engine 56 and the file comparison utility 58 may be utilized to compare objects in the open markup language API DOMs 52 and 54 which are representative of the parts 42 and 45.

From operation 315, the routine 300 continues to operation 320, where the computer 2 utilizes the comparison engine 56 and the file comparison utility 58 to compare the elements 43 and 46 (in the source and target markup language documents 40 and 44) to determine added, removed, or modified markup language elements. In particular, the comparison engine 56 and the file comparison utility 58 may be utilized to compare markup language elements in source open markup language document 40 and markup language elements in the target open markup language document 44 to determine an addition of markup language elements, to determine a removal of markup language elements, to determine a modification of markup language elements, or to determine that there is no difference between the markup language elements 43 in the source open markup language document 40 and the markup language elements 46 in the target markup language document 44. In accordance with an embodiment, the comparison engine 56 and the file comparison utility 58 may be utilized to compare objects in the open markup language API DOMs 52 and 54 which are representative of the elements 43 and 46.

From operation 320, the routine 300 continues to operation 325, where the computer 2 utilizes the comparison engine 56 and the file comparison utility 58 to mark any changes in the elements 43 by mapping the comparison result (i.e., the open markup language comparison result 60) to the open markup language API DOM 52.

From operation 325, the routine 300 continues to operation 330, where the computer 2 utilizes the code reflector 62 to generate computer program code representing the differences between the parts 42 and 45 as well as the differences between the elements 43 and 46, in the source and target open markup language documents 40 and 44. In particular, the code reflector 62 may be utilized to generate computer program code representing the differences between the document structure of the source open markup language document 40 and the document structure of the target open markup language document 44 as well as generate computer program code representing the differences between markup language elements in the source open markup language document 40 and markup language elements in the target open markup language document 44. In accordance with an embodiment, the code reflector 62 may be utilized to generate the code DOM 64 which reflects the changes between the source and target open markup language documents 40 and 44.

From operation 330, the routine 300 continues to operation 335, where the computer 2 utilizes the code viewer 70 to display the computer program code generated by the code reflector 62 in a user interface. It should be appreciated that the displayed computer program code may facilitate identifying the locations of overall document changes as well as changes to text, paragraphs, styles, comments, headers, footers, and charts in electronic office documents which have been modified in an open markup language file format such as Open XML. From operation 335, the routine 300 then ends.

Turning now to FIG. 4, an illustrative routine 400 for generating computer program code from open markup language parts will now be described, in accordance with an embodiment. The routine 400 begins at operation 405, where the computer 2 loads a source open markup language part 42. In particular, the central processing unit 8 in the computer 2 may utilize the open markup language API 48 to load a part 42 as a document object model (i.e., the open markup language API DOM 52) representing the elements 43 in a source open markup language part 42.

From operation 405, the routine 400 continues to operation 410, where the computer 2 loads a target open markup language part 45. In particular, the central processing unit 8 in the computer 2 may utilize the target markup language API 48 to load a target open markup language part 45 as a document object model (i.e., the open markup language API DOM 54) representing the elements 46 in a target open markup language part 45. It should be understood that in accordance with other embodiments, the operations 405 and 410 may be reversed. That is, the computer 2 may load a target open markup language part 45 prior to loading a source open markup language part 42.

From operation 410, the routine 400 continues to operation 415, where the computer 2 utilizes the comparison engine 56 and the file comparison utility 58 to compare the elements 43 and 46 (in the source and target markup language parts 42 and 45) to determine added, removed, or modified markup language elements. In particular, the comparison engine 56 and the file comparison utility 58 may be utilized to compare markup language elements in the source open markup language part 42 and markup language elements in the target open markup language part 45 to determine an addition of markup language elements, to determine a removal of markup language elements, to determine a modification of markup language elements, or to determine that there is no difference between the markup language elements 43 in the source open markup language part 42 and the markup language elements 46 in the target open markup language part 45. In accordance with an embodiment, the comparison engine 56 and the file comparison utility 58 may be utilized to compare objects in the open markup language API DOMs 52 and 54 which are representative of the elements 43 and 46.

From operation 415, the routine 400 continues to operation 420, where the computer 2 utilizes the comparison engine 56 to mark any changes in the elements 43 by mapping the comparison result (i.e., the open markup language comparison result 60) to the open markup language API DOM 52.

From operation 420, the routine 400 continues to operation 425, where the computer 2 utilizes the code reflector 62 to generate computer program code representing the differences the elements 43 and 46, in the source and target open markup language parts 42 and 45. In particular, the code reflector 62 may be utilized to generate the code DOM 64 which reflects changes between the source and target open markup language parts 42 and 45.

From operation 425, the routine 400 continues to operation 430, where the computer 2 utilizes the code viewer 70 to display the computer program code generated by the code reflector 62 in a user interface. It should be appreciated that the displayed computer program code may facilitate identifying the locations of overall document changes as well as changes to text, paragraphs, styles, comments, headers, footers, and charts in electronic office document parts which have been modified in an open markup language file format such as Open XML. From operation 430, the routine 400 then ends.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of generating computer program code from open markup language documents, comprising:
loading, by the computer, a source open markup language document;
loading, by the computer, a target open markup language document;
comparing, by the computer, content in the source open markup language document and content in the target open markup language document to determine differences; and
generating computer program code representative of the differences between the source and target markup language documents.

2. The method of claim 1, further comprising displaying, by the computer, the generated computer program code in a user interface.

3. The method of claim 1, wherein loading a source open markup language document comprises utilizing an application programming interface to load the source open markup language document as a document object model representing markup language elements in the source open markup language document, the markup language elements comprising at least one markup language part.

4. The method of claim 1, wherein loading a target open markup language document comprises utilizing an application programming interface to load the target open markup language document as a document object model representing markup language elements in the target open markup language document, the markup language elements comprising at least one markup language part.

5. The method of claim 1, wherein comparing content in the source open markup language document and content in the target open markup language document to determine differences comprises:
comparing a document structure of the source open markup language document and a document structure of the target open markup language document to determine at least one of an addition of a markup language part to the source open markup language document, a removal of a markup language part from the source open markup language document, and no difference in a markup language part in the source open markup language document and a markup language part in the target markup language document;
comparing any markup language elements in the at least one markup language part in the source open markup language document and any markup language elements in the at least one markup language part in the target open markup language document to determine at least one of an addition of the any markup language elements, a removal of the any markup language elements, a modification of the any markup language elements, and no difference between the any markup language elements in the at least one markup language part in the source open markup language document and the at least one markup language part in target markup language document; and
marking changes between the any markup language elements in the at least one markup language part in the source open markup language document and the any markup language elements in the at least one markup language part in the target open markup language document.

6. The method of claim 5, wherein marking changes between the any markup language elements in the at least one markup language part in the source open markup language document and the any markup language elements in the at least one markup language part in the target open markup language document comprises mapping the result of the comparison of the any markup language elements in the at least one markup language part in the source open markup language document and the any markup language elements in the at least one markup language part in the target open markup language document to a document object model.

7. The method of claim 5, wherein generating computer program code representative of the differences between the source and target markup language documents comprises:
generating computer program code representing the differences between the document structure of the source open markup language document and the document structure of the target open markup language document; and
generating computer program code representing the differences between the any markup language elements in the at least one markup language part in the source open markup language document and the any markup language elements in the at least one markup language part in the target open markup language document.

8. A computer system for generating computer program code from open markup language parts, comprising:
a memory for storing executable program code; and
a processor, functionally coupled to the memory, the processor being responsive to computer-executable instructions contained in the program code and operative to:
load a source open markup language part;
load a target open markup language part;
compare content in the source open markup language part and content in the target open markup language part to determine differences; and
generate computer program code representative of the differences between the source and target markup language parts.

9. The computer system of claim 8, wherein the processor is further operative to display the generated computer program code in a user interface.

10. The computer system of claim 9, wherein the processor, in loading a source open markup language part, is operative to utilize an application programming interface to load the source open markup language part as a document object model representing markup language elements in the source open markup language part.

11. The computer system of claim 9, wherein the processor, in loading a target open markup language part, is operative to utilize an application programming interface to load the target open markup language part as a document object model representing markup language elements in the target open markup language part.

12. The computer system of claim 9, wherein the processor, in comparing content in the source open markup language part and content in the target open markup language part to determine differences, is operative to compare any markup language elements in the source open markup language part and any markup language elements in the target open markup language part to determine at least one of an addition of the any markup language elements, a removal of the any markup language elements, a modification of the any markup language elements, and no difference between the any markup language elements in the source open markup language part and the target open markup language part.

13. The computer system of claim 12, wherein the processor, in comparing content in the source open markup language part and content in the target open markup language part to determine differences, is further operative to mark changes between the any markup the any markup language elements in the source open markup language part and the any markup language elements in the target open markup language part.

14. The computer system of claim 13, wherein the processor, in marking changes between the any markup language elements in the source open markup language part and the any markup language elements in the target open markup language part comprises mapping the result of the comparison of the any markup language elements in the source open markup language part and the any markup language elements in the target open markup language part to a document object model.

15. The computer system method of claim 12, wherein the processor, in generating computer program code representative of the differences between the source and target markup language parts, is operative to generate computer program code representing the differences between the any markup language elements in the source open markup language part and the any markup language elements in the target open markup language part.

16. A computer-readable storage medium comprising computer executable instructions which, when executed by a computer, will cause the computer to perform a method of generating computer program code from open markup language documents, comprising:
utilizing an application programming interface to load a source open markup language document as a document object model representing markup language elements in the source open markup language document, the markup language elements comprising at least one markup language part;
utilizing the application programming interface to load a target markup language document as a document object model representing markup language elements in a target open markup language document, the markup language elements comprising at least one markup language part;
comparing content in the source open markup language document and content in the target open markup language document to determine differences; and
generating computer program code representative of the differences between the source and target markup language documents.

17. The computer-readable storage medium of claim 16, further comprising displaying the generated computer program code in a user interface.

18. The computer-readable storage medium of claim 16, wherein comparing content in the source open markup language document and content in the target open markup language document to determine differences comprises:
comparing a document structure of the source open markup language document and a document structure of the target open markup language document to determine at least one of an addition of a markup language part to the source open markup language document, a removal of a markup language part from the source open markup language document, and no difference in a markup language part in the source open markup language document and a markup language part in the target markup language document;
comparing any markup language elements in the at least one markup language part in the source open markup language document and any markup language elements in the at least one markup language part in the target open markup language document to determine at least one of an addition, a removal, a modification of the any markup language elements, and no difference between the any markup language elements in the at least one markup language part in the source open markup language document and the at least one markup language part in the target open markup language document; and
marking changes between the any markup language elements in the at least one markup language part in the source open markup language document and the any markup language elements in the at least one markup language part in the target open markup language document.

19. The computer-readable storage medium of claim 18, wherein marking changes between the any markup language elements in the at least one markup language part in the source open markup language document and the any markup language elements in the at least one markup language part in the target open markup language document comprises mapping the result of the comparison of the any markup language elements in the at least one markup language part in the source open markup language document and the any markup language elements in the at least one markup language part in the target open markup language document to a document object model.

20. The computer-readable storage medium of claim 18, wherein generating computer program code representative of the differences between the source and target markup language documents comprises:
generating computer program code representing the differences between the document structure of the source open markup language document and the document structure of the target open markup language document; and
generating computer program code representing the differences between the any markup language elements in the at least one markup language part in the source open markup language document and the any markup language elements in the at least one markup language part in the target open markup language document.
